(19) United States
(12) Patent Application Publication
(10) Pub. No.: US 2019/0182019 A1
(43) Pub. Date: Jun. 13, 2019

(54) RADIO COMMUNICATION APPARATUS AND METHOD OF CONTROLLING PHASE OF REFLECTED WAVE

(71) Applicant: FUJITSU LIMITED, Kawasaki-shi (JP)

(72) Inventors: Tsuneaki Tadano, Sendai (JP); Kouichi Hayasaka, Sendai (JP); Tatsuhiko Tajima, Tagajo (JP); Kenji Iwai, Sapporo (JP)

(73) Assignee: FUJITSU LIMITED, Kawasaki-shi (JP)

(21) Appl. No.: 16/201,890

(22) Filed: Nov. 27, 2018

(30) Foreign Application Priority Data
Dec. 12, 2017 (JP) 2017-238108

(51) Int. Cl. H04L 5/14; H04W 56/00; H04B 7/26; H04J 3/06

(52) U.S. Cl. CPC H04L 5/1461; H04J 3/0685; H04B 7/2643; H04W 56/0035

(57) ABSTRACT

A radio communication apparatus transmits a transmission signal amplified by a first amplifier via a circulator and amplifies a received signal received via the circulator by a second amplifier. The radio communication apparatus includes: a controller that outputs control information based on a signal level between the first amplifier and the circulator; and a phase shifter that is provided between the circulator and the second amplifier and adjusts a phase of a reflected wave generated from an input side of the second amplifier based on the control information.

### CROSS-REFERENCE TO RELATED APPLICATION(S)

This application is based upon and claims the benefit of priority of the prior Japanese Patent Application No. 2017-238108, filed on Dec. 12, 2017, the entire contents of which are incorporated herein by reference.

### FIELD

The embodiments discussed herein are related to a radio communication apparatus and a method of controlling a phase of a reflected wave.

### BACKGROUND

An example of a radio communication apparatus using a time division duplex (TDD) method will be described. The radio communication apparatus using the TDD method transmits a radio signal in a transmission period (TX period) and receives a radio signal in a reception period (RX period).

In the TX period, a baseband signal is multiplied by a distortion compensation coefficient described later by an arithmetic processor. A signal output from the arithmetic processor is converted into an analog signal by a digital to analog converter (DAC). A quadrature modulator (QMOD) up-converts the signal converted into the analog signal to a radio frequency by using a signal output from an oscillator, and outputs the up-converted signal to a power amplifier (PA). The PA enters an idle state according to an input idle voltage and amplifies the signal output from the QMOD. The signal output from the PA is branched into two.

One signal output from the PA is input to a band pass filter (BPF) via a directional coupler and a circulator. The BPF causes a signal of a specific frequency band to pass through with respect to one signal output from the PA and attenuates signals of other frequency bands. The signal that has passed through the BPF is transmitted as a transmission signal (radio signal) to an external receiving device via the antenna.

The other signal output from the PA is input to a quadrature demodulator (QDEM) on a feedback (FB) side via the directional coupler. The QDEM on the FB side down-converts the signal fed back from the PA via the directional coupler to a frequency of the baseband signal by using the signal output from the oscillator on the FB side and outputs the down-converted signal to an analog-to-digital converter (ADC) on the FB side. The signal output from the QDEM on the FB side is converted into a digital signal by the ADC on the FB side and output as a FB signal. The arithmetic processor generates the distortion compensation coefficient such that a difference between the FB signal output from the ADC on the FB side and the baseband signal is minimized and multiplies the baseband signal by the distortion compensation coefficient.

Here, in the TX period, a terminating resistor is selected out of a low noise amplifier (LNA) and the terminating resistor by a switch (SW). As a result, a reflected wave moving from an end portion of an antenna to the LNA via the BPF and the circulator is terminated. Therefore, in the TX period, the radio communication apparatus can secure a value of a voltage standing wave ratio (VSWR) at an ideal value without being influenced by the reflected wave.

In the RX period, the PA enters a pinch-off state according to an input pinch-off voltage. Furthermore, the LNA is selected out of the LNA and the terminating resistor by the SW. As a result, a received signal (radio signal) received by an antenna is output to the LNA via the BPF and the circulator. The LNA amplifies the power of the received signal. The QDEM on the RX side down-converts the signal output from the LNA to a frequency of the baseband signal by using the signal output from the oscillator on the RX side and outputs the down-converted signal to the ADC on the RX side. The ADC on the RX side converts the signal output from the QDEM on the RX side into a digital signal and outputs the digital signal as a baseband signal.

Patent Document 1: Japanese Laid-open Patent Publication No. 2004-301562

Patent Document 2: Japanese Laid-open Patent Publication No. 2001-292004

However, when the LNA is selected by the SW in the RX period and as a result, the received signal is input to the LNA, a reflected wave is generated from an input side of the LNA. Then, the reflected wave from the input side of the LNA passes through the circulator and the directional coupler to move to the PA. Since in the RX period, the PA is in the pinch-off state, the reflected wave from an output side of the PA passes through the directional coupler, the circulator, and the BPF to reach the antenna.

Furthermore, in the RX period, for example, the received signal (received wave) leaked from the circulator to the PA side passes through the directional coupler to move to the PA. Even in this case, since in the RX period, the PA is in the pinch-off state, the reflected wave from the output side of the PA passes through the directional coupler, the circulator, and the BPF to reach the antenna.

As described above, since the radio communication apparatus is influenced by the reflected wave in the RX period, it is difficult to secure the value of the VSWR at the ideal value.

Therefore, for the reflected wave from the input side of the LNA, it is conceivable that, for example, a circulator that terminates the reflected wave from the input side of the LNA (hereinafter referred to as another circulator) is provided between the circulator and the LNA. For example, in the RX period, the LNA is selected by the SW. As a result, the radio signal received by the antenna is output to the LNA via the BPF and the circulator. Here, the reflected wave from the input side of the LNA is terminated by being input from another circulator to the terminating resistor of 50Ω on the way to the circulator.

However, when another circulator is provided between the circulator and the SW, since the two circulators are used, the mounting area of the apparatus increases. That is, the circuit scale of the apparatus increases. As described above, in the RX period, it is desirable to improve the VSWR without terminating the reflected wave from the input side of the LNA by the circulator.

### SUMMARY

According to an aspect of an embodiment, a radio communication apparatus transmits a transmission signal amplified by a first amplifier via a circulator and amplifies a received signal received via the circulator by a second amplifier. The radio communication apparatus includes: a controller that outputs control information based on a signal level between the first amplifier and the circulator; and a phase shifter that is provided between the circulator and the second amplifier and adjusts a phase of a reflected wave generated from an input side of the second amplifier based on the control information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a radio communication apparatus according to an embodiment;

FIG. 2 is a diagram for describing a transmission period (TX period) in FIG. 1;

FIG. 3 is a diagram for describing a reception period (RX period) in FIG. 1;

FIG. 4 is a timing chart illustrating the TX period and the RX period in FIG. 1;

FIG. 5 is a flowchart illustrating an example of VSWR processing of the radio communication apparatus according to the embodiment;

FIG. 6 is a graph for describing the VSWR processing in FIG. 5; and

FIG. 7 is a diagram illustrating an example of a hardware configuration of the radio communication apparatus.

### DESCRIPTION OF EMBODIMENTS

Preferred embodiments of the present invention will be explained with reference to accompanying drawings. Note that the present invention is not limited by the following embodiments.

Radio Communication Apparatus

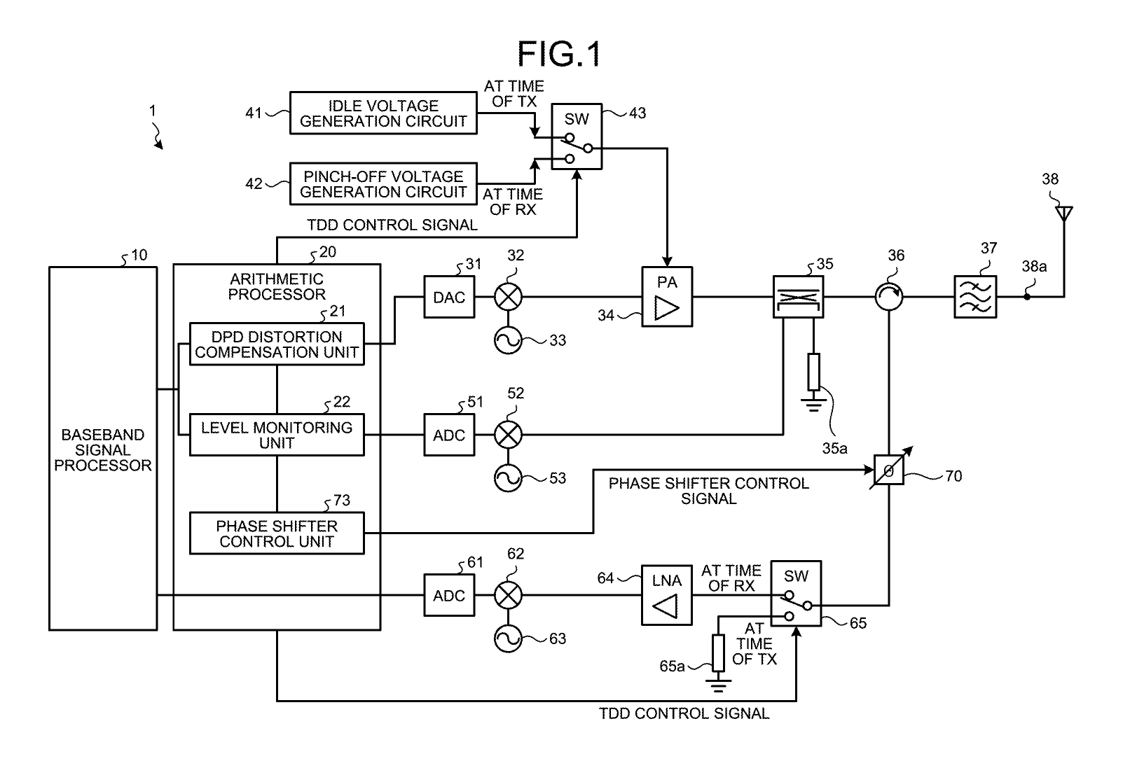

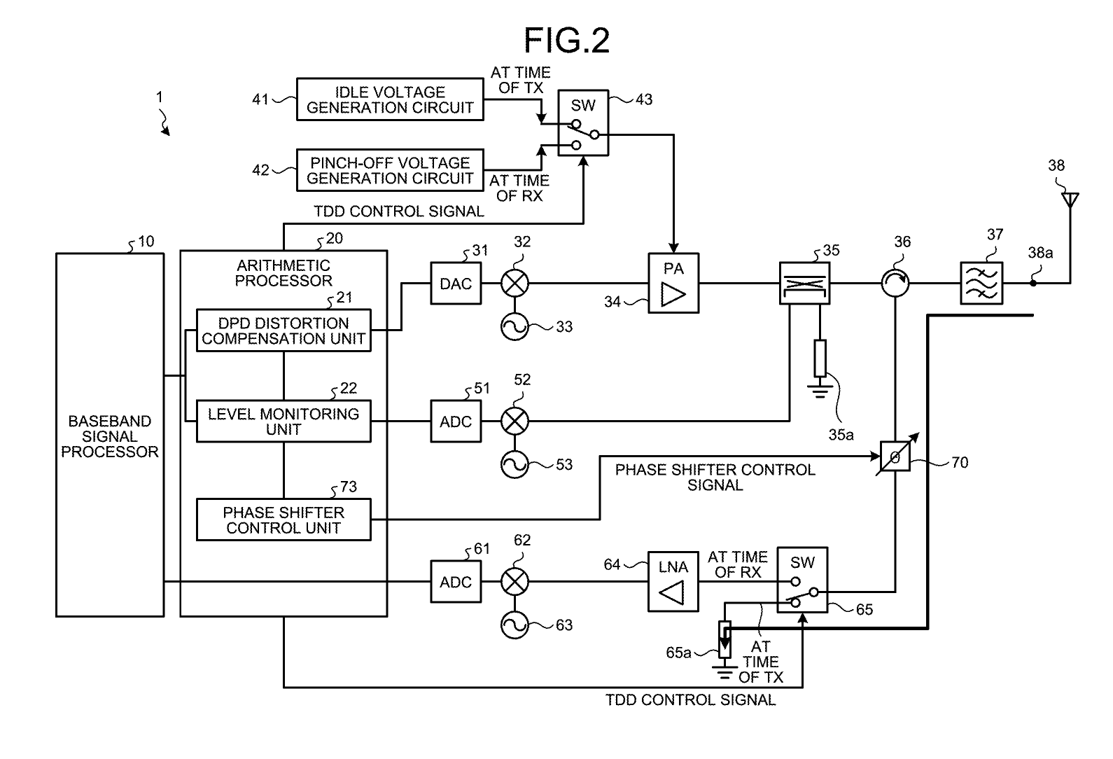

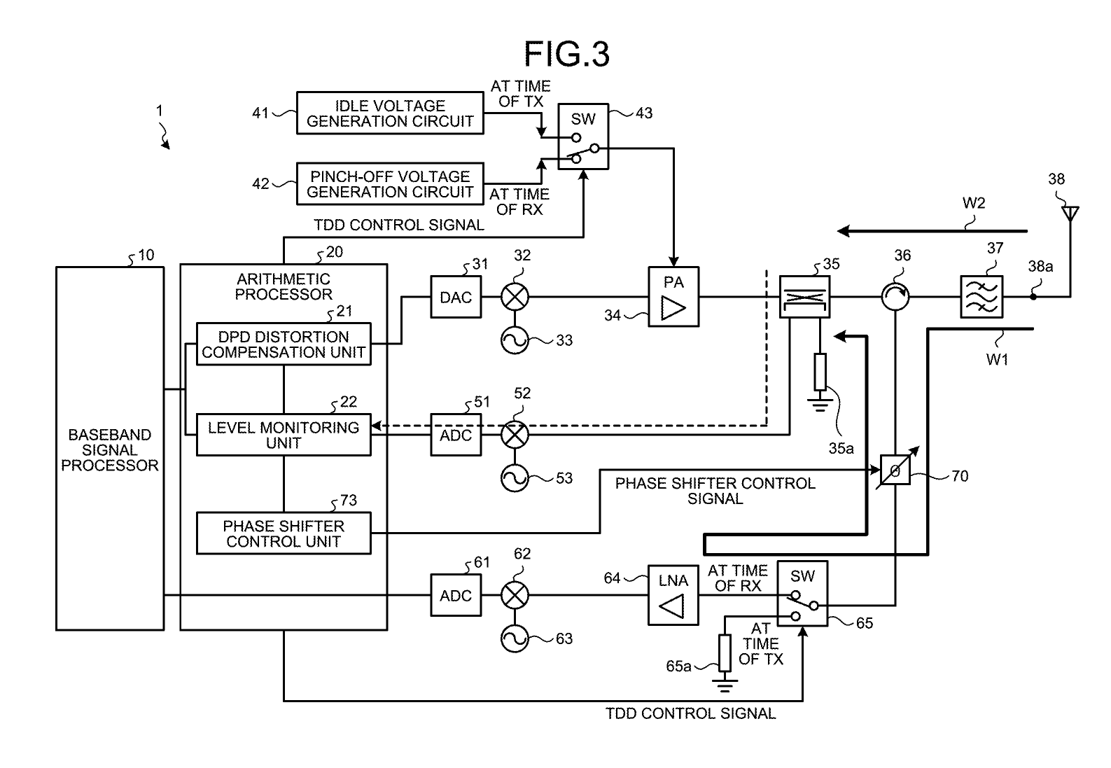

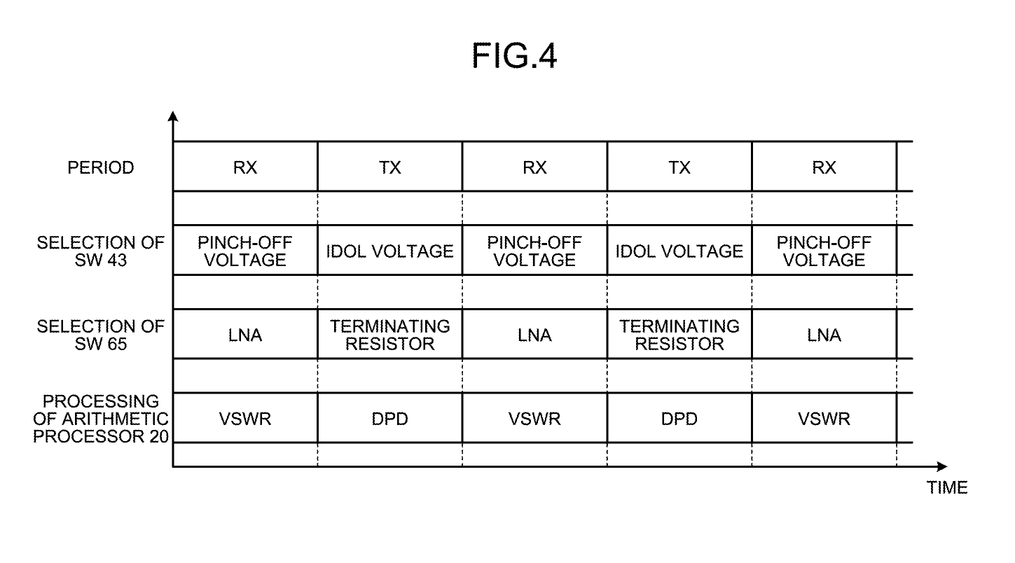

FIG. 1 is a block diagram illustrating an example of a radio communication apparatus 1 according to the embodiment. FIG. 2 is a diagram for describing a transmission period (TX period) in FIG. 1. FIG. 3 is a diagram for describing a reception period (RX period) in FIG. 1. FIG. 4 is a timing chart illustrating the TX period and the RX period in FIG. 1.

The radio communication apparatus 1 illustrated in FIG. 1 is a radio communication apparatus using a time division duplex (TDD) method and applied to a base station and a terminal.

As illustrated in FIG. 1, the radio communication apparatus 1 according to the embodiment includes a baseband signal processor 10 and an arithmetic processor 20.

Furthermore, the radio communication apparatus 1 includes a digital-to-analog converter (DAC) 31, a quadrature modulator (QMOD) 32, a phase locked loop (PLL) oscillator 33, and a power amplifier (PA) 34. Furthermore, the radio communication apparatus 1 includes a directional coupler 35, a circulator 36, a band pass filter (BPF) 37, and an antenna 38.

Furthermore, the radio communication apparatus 1 includes an idle voltage generation circuit 41, a pinch-off voltage generation circuit 42, and a switch (SW) 43.

Furthermore, the radio communication apparatus 1 includes an analog-to-digital converter (ADC) 51, a quadrature demodulator (QDEM) 52, and a PLL oscillator 53 provided on a feedback side.

Furthermore, the radio communication apparatus 1 includes an ADC 61, a QDEM 62, a PLL oscillator 63, a low noise amplifier (LNA) 64, and a switch (SW) 65 provided on a reception side. Furthermore, the radio communication apparatus 1 includes a phase shifter 70.

Here, the arithmetic processor 20 is, for example, a field programmable gate array (FPGA), and includes a digital pre-distortion (DPD) distortion compensation unit 21, a level monitoring unit 22, and a phase shifter control unit 73.

As a main line, the directional coupler 35 has an input connected to the PA 34 and an output connected to the circulator 36. Furthermore, as a couple line, the directional coupler 35 has one side connected to the QDEM 52 and an opposite side connected to a terminating resistor 35a of 50Ω.

The SW 43 is a single pole double throw (SPDT) type switch, the idle voltage generation circuit 41 is connected to one of two inputs, the pinch-off voltage generation circuit 42 is connected to the other input, and the PA 34 is connected to an output.

The idle voltage generation circuit 41 generates an idle voltage for putting the PA 34 into an idle state.

The pinch-off voltage generation circuit 42 generates a pinch-off voltage for putting the PA 34 into a pinch-off state.

The SW 65 is an SPDT type switch, the circulator 36 is connected to an input via the phase shifter 70, a terminating resistor 65a of 50Ω is connected to one of two outputs, and an input of the LNA 64 is connected to the other output.

The radio communication apparatus 1 according to the embodiment transmits a radio signal in the transmission period (TX period).

In the TX period, a DPD distortion compensation unit 21 of the arithmetic processor 20 obtains a baseband signal output from the baseband signal processor 10. Furthermore, the DPD distortion compensation unit 21 obtains a distortion compensation coefficient generated by the level monitoring unit 22. Then, the DPD distortion compensation unit 21 multiplies the baseband signal by the distortion compensation coefficient. The DPD distortion compensation unit 21 outputs a signal obtained by multiplying the baseband signal by the distortion compensation coefficient to the DAC 31.

The DAC 31 obtains the signal output from the DPD distortion compensation unit 21. The DAC 31 converts the obtained signal into an analog signal and outputs the analog signal to the QMOD 32.

The QMOD 32 obtains the signal output from the PLL oscillator 33. Furthermore, the QMOD 32 obtains the signal converted into the analog signal by the DAC 31. Then, using the signal output from the PLL oscillator 33, the QMOD 32 up-converts the signal converted into the analog signal to a radio frequency. The QMOD 32 outputs the up-converted signal to the PA 34.

The SW 43 selects the idle voltage generated by the idle voltage generation circuit 41 according to the TDD control signal output from the arithmetic processor 20 during the TX period (see FIGS. 2 and 4). The SW 43 outputs the selected idle voltage to the PA 34.

The PA 34 obtains the idle voltage output from SW 43. Furthermore, the PA 34 obtains the signal output from the QMOD 32. Then, the PA 34 enters an idle state according to the idle voltage and amplifies the signal output from the QMOD 32. The signal output from PA 34 is branched into two. Here, the PA 34 is an example of a “first amplifier”.

One signal output from the PA 34 is input to the BPF 37 via the directional coupler 35 and the circulator 36. The BPF 37 causes a signal of a specific frequency band to pass through with respect to one signal output from the PA 34 and attenuates signals of other frequency bands. The signal that has passed through the BPF 37 is transmitted as a transmission signal (radio signal) to an external receiving device via the antenna 38.

The other signal output from the PA 34 is input to the QDEM 52 via the directional coupler 35. The QDEM 52 obtains a signal output from the PLL oscillator 53. Furthermore, the QDEM 52 obtains a signal fed back from the PA 34 via the directional coupler 35. Then, using the signal output from the PLL oscillator 53, the QDEM 52 down-converts the signal fed back from the PA 34 via the directional coupler 35 to a frequency of the baseband signal. The QDEM 52 outputs the down-converted signal to the ADC 51.

The ADC 51 obtains the signal output from the QDEM 52. The ADC 51 converts the obtained signal into a digital signal and outputs the digital signal as a feedback (FB) signal to the arithmetic processor 20. Here, the directional coupler 35, the QDEM 52, and the ADC 51 are an example of a “feedback path”.

The arithmetic processor 20 obtains the FB signal input from an output side of the PA 34 via the feedback path (directional coupler 35, QDEM 52, and ADC 51) in the TX period, thereby executing DPD processing depicted below (see FIG. 4).

In the DPD processing, the level monitoring unit 22 of the arithmetic processor 20 obtains the FB signal output from the ADC 51. Furthermore, the level monitoring unit 22 obtains the baseband signal output from the baseband signal processor 10. Then, the level monitoring unit 22 generates the distortion compensation coefficient on the basis of a difference between the FB signal and the baseband signal. For example, the level monitoring unit 22 obtains the distortion compensation coefficient such that the difference between the FB signal and the baseband signal is minimized by the processing using a least mean square (LMS) algorithm or the like. The level monitoring unit 22 outputs the obtained distortion compensation coefficient to the DPD distortion compensation unit 21. Then, the DPD distortion compensation unit 21 outputs a signal obtained by multiplying the baseband signal by the distortion compensation coefficient to the DAC 31. Here, the DPD distortion compensation unit 21 is an example of a “distortion compensation unit”.

Here, in the TX period, the SW 65 on the RX side selects the terminating resistor 65a of 50Ω according to the TDD control signal output from the arithmetic processor 20 during the TX period (see FIGS. 2 and 4). The SW 65 selects the terminating resistor 65a out of the LNA 64 and the terminating resistor 65a, whereby as illustrated in FIG. 2, the reflected wave moving from an end portion 38a of the antenna 38 toward the LNA 64 via the BPF 37, the circulator 36, and the phase shifter 70 is terminated. Therefore, in the TX period, the radio communication apparatus 1 is not influenced by the reflected wave and can secure the value of the voltage standing wave ratio (VSWR) at the ideal value.

The radio communication apparatus 1 according to the embodiment receives a radio signal in the reception period (RX period).

In the RX period, the SW 43 selects the pinch-off voltage generated by the pinch-off voltage generation circuit 42 according to the TDD control signal output from the arithmetic processor 20 during the RX period (see FIGS. 3 and 4). The SW 43 outputs the selected pinch-off voltage to the PA 34.

The PA 34 obtains the pinch-off voltage output from SW 43. In this case, the PA 34 enters the pinch-off state according to the pinch-off voltage.

The SW 65 selects the LNA 64 according to the TDD control signal output from the arithmetic processor 20 in the RX period (see FIGS. 3 and 4). In this case, the received signal (radio signal) received by the antenna 38 is output to the LNA 64 via the BPF 37, the circulator 36, and the phase shifter 70.

The LNA 64 obtains the signal output from the SW 65. The LNA 64 amplifies the power of the obtained signal and outputs to the QDEM 62. Here, the LNA 64 is an example of a “second amplifier”.

The QDEM 62 obtains a signal output from the PLL oscillator 63. Furthermore, the QDEM 62 obtains the signal output from the LNA 64. Then, using a signal output from the PLL oscillator 63, the QDEM 62 down-converts the signal output from the LNA 64 to the frequency of the baseband signal. The QDEM 62 outputs the down-converted signal to the ADC 61.

The ADC 61 obtains the signal output from the QDEM 62. The ADC 61 converts the obtained signal into a digital signal and outputs the digital signal as a feedback (FB) signal to the arithmetic processor 20.

The arithmetic processor 20 outputs the baseband signal output from the ADC 61 to the baseband signal processor 10.

Here, in the RX period, SW 65 selects LNA 64, whereby when the received signal is input to LNA 64, a reflected wave is generated from the input side of the LNA 64. Then, the reflected wave from an input side of the LNA 64 passes through the phase shifter 70, the circulator 36, and the directional coupler 35 to move to the PA 34 (see arrow W1 in FIG. 3). In the RX period, since the PA 34 is in the pinch-off state, the reflected wave from an output side of the PA 34 passes through the directional coupler 35, the circulator 36, and the BPF 37 and reaches the end portion 38a of the antenna 38.

Furthermore, in the RX period, for example, the received signal (received wave) leaked from the circulator 36 to a side of the PA 34 passes through the directional coupler 35 and moves to the PA 34 (see arrow W2 in FIG. 3). Even in this case, since in the RX period, the PA 34 is in the pinch-off state, the reflected wave from the output side of the PA 34 passes through the directional coupler 35, the circulator 36, and the BPF 37 and reaches the end portion 38a of the antenna 38.

In this case, since in the RX period, the radio communication apparatus 1 is influenced by the reflected wave, it is impossible to secure the value of the VSWR at the ideal value. Therefore, in the present embodiment, in the RX period, the arithmetic processor 20 executes the VSWR processing depicted below (see FIG. 4).

In the VSWR processing, the level monitoring unit 22 of the arithmetic processor 20 monitors a signal level between the PA 34 and the circulator 36. Specifically, the level monitoring unit 22 monitors the signal level input from the feedback path (directional coupler 35, QDEM 52, and ADC 51) between the PA 34 and the circulator 36. In the radio communication apparatus 1 according to the embodiment, in order to suppress an increase in the circuit scale of the apparatus, the feedback path is made common between the DPD process and the VSWR processing.

The signal level represents a signal level resulting from a combination of a reflected wave generated from the input side of the LNA 64 and a received signal (received wave) leaked from the circulator 36 to the side of the PA 34. The level monitoring unit 22 outputs the monitored signal level to the phase shifter control unit 73. Here, the level monitoring unit 22 is an example of a “monitoring unit”.

The phase shifter control unit 73 obtains the signal level monitored by the level monitoring unit 22. At this time, the phase shifter control unit 73 outputs a control signal having a minimum signal level to the phase shifter 70.

The phase shifter 70 obtains the control signal output from the phase shifter control unit 73. The phase shifter 70 adjusts the phase of the reflected wave generated from the input side of the LNA 64 on the basis of the obtained control signal.

In the present embodiment, the phase shifter control unit 73 outputs the control signal to the phase shifter 70 and adjusts the phase of the reflected wave from the input side of the LNA 64 by the phase shifter 70, thereby canceling the received signal (received wave) leaked from the circulator 36 to the side of the PA 34. Here, “canceling” means canceling out or attenuating. For example, the phase shifter control unit 73 adjusts the phase of the reflected wave from the input side of the LNA 64 by the phase shifter 70, thereby minimizing the signal level resulting from the combination of the reflected wave and the received signal (received wave). As a result, the level of the reflected wave reaching the end portion 38a of the antenna 38 becomes small, and also in the RX period, the radio communication apparatus 1 is not influenced by the reflected wave and can secure the value of the VSWR at the ideal value. Here, the phase shifter control unit 73 is an example of a “control unit”.

As described above, with the radio communication apparatus 1 according to the embodiment, by using the phase shifter 70, it may be unnecessary to provide a circulator that terminates the reflected wave from the input side of the LNA 64 between the circulator 36 and the LNA 64 (specifically SW 65). Therefore, with the radio communication apparatus 1 according to the embodiment, the circulator that terminates the reflected wave from the input side of the LNA 64 is not used, whereby the increase in the circuit scale of the apparatus can be suppressed. Furthermore, in the radio communication apparatus 1 according to the embodiment, the phase of the reflected wave from the input side of the LNA 64 is adjusted by the phase shifter 70 in the RX period, whereby the received wave leaked from the circulator 36 to the side of the PA 34 is canceled (canceled out or attenuated). Therefore, with the radio communication apparatus 1 according to the embodiment, the VSWR can be improved as compared with a method of terminating a reflected wave with a circulator.

Operation

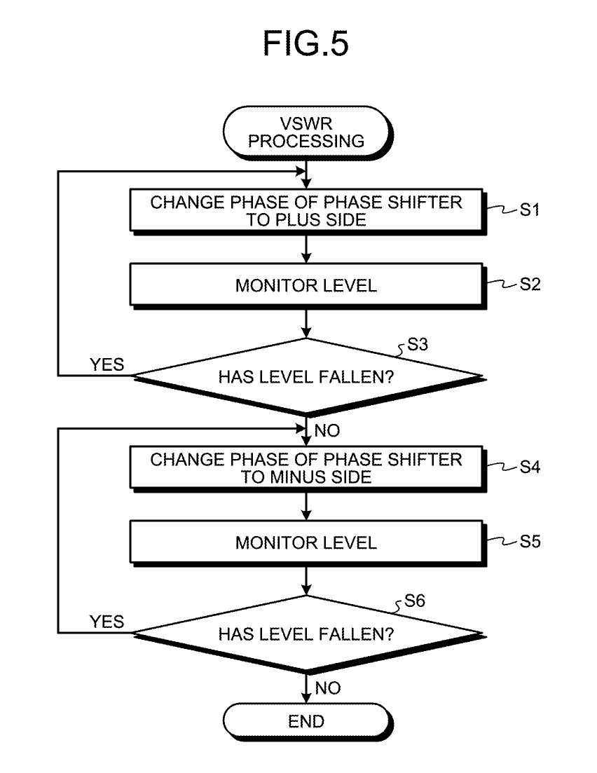

FIG. 5 is a flowchart illustrating an example of the VSWR processing of the radio communication apparatus 1 according to the embodiment.

The phase shifter control unit 73 adjusts the phase of the reflected wave from the input side of the LNA 64 by adjusting the phase of the phase shifter 70 according to the control signal. At this time, the phase shifter control unit 73 searches for a phase (optimum phase) at which the signal level monitored by the level monitoring unit 22 is the smallest. Here, the optimal phase fluctuates depending on variations in the accuracy of the parts of the radio communication apparatus 1 and environmental temperature. Therefore, in the VSWR processing, the phase of the phase shifter 70 is changed in a plus direction or a minus direction to search for the optimum phase.

First, when the phase shifter control unit 73 obtains the signal level monitored by the level monitoring unit 22, the phase shifter control unit 73 changes the phase of the phase shifter 70 to a plus side. That is, the phase shifter control unit 73 changes the phase of the phase shifter 70 in the plus direction by a preset phase (hereinafter referred to as set phase) (Step S1).

At this time, the level monitoring unit 22 monitors the signal level input from the feedback path (directional coupler 35, QDEM 52, and ADC 51) (Step S2).

The phase shifter control unit 73 obtains the signal level monitored by the level monitoring unit 22. At this time, the phase shifter control unit 73 determines whether the currently obtained signal level (current level) from the level monitoring unit 22 has fallen below the previously obtained signal level (previous level) from the level monitoring unit 22 (Step S3).

Here, in a case where the current level has fallen below the previous level (Step S3; Yes), Step S1 is executed.

On the other hand, in a case where the current level has not fallen below the previous level (Step S3; No), the phase shifter control unit 73 changes the phase of the phase shifter 70 to a minus side. That is, the phase shifter control unit 73 changes the phase of the phase shifter 70 in the minus direction by the set phase (Step S4).

At this time, the level monitoring unit 22 monitors the signal level input from the feedback path (directional coupler 35, QDEM 52, and ADC 51) (Step S5).

The phase shifter control unit 73 obtains the signal level monitored by the level monitoring unit 22. At this time, the phase shifter control unit 73 determines whether the currently obtained signal level (current level) from the level monitoring unit 22 has fallen below the previously obtained signal level (previous level) from the level monitoring unit 22 (Step S6).

Here, in a case where the current level has fallen below the previous level (Step S6; Yes), Step S4 is executed.

On the other hand, in a case where the current level has not fallen below the previous level (Step S6; No), the phase shifter control unit 73 determines a phase at the time of adjustment to the previous level as the optimum phase.

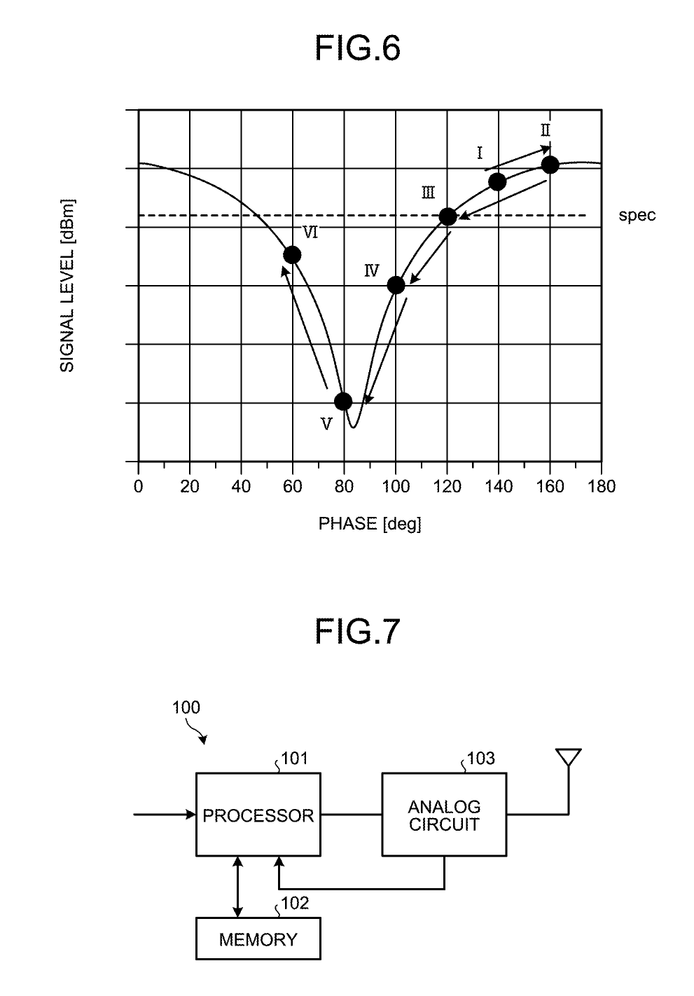

The VSWR processing in FIG. 5 will be described in detail with reference to FIG. 6. FIG. 6 is a diagram for describing the VSWR processing in FIG. 5. Here, in FIG. 6, a horizontal axis represents the phase (deg) of the phase shifter 70. A vertical axis represents the signal level (dBm) input from the feedback path (directional coupler 35, QDEM 52, and ADC 51). That is, the vertical axis represents the signal level monitored by the level monitoring unit 22.

For example, an initial value of the phase of the phase shifter 70 is assumed to be 140 degs. The phase shifter control unit 73 obtains a signal level “I” monitored by the level monitoring unit 22. At this time, the phase of the phase shifter 70 is adjusted in the plus direction. For example, the phase shifter control unit 73 changes the phase of the phase shifter 70 from the initial value of 140 degs. by +20 degs. as the set phase (Step S1).

Next, the level monitoring unit 22 monitors a signal level “II” input from the feedback path (directional coupler 35, QDEM 52, and ADC 51) (Step S2). The phase shifter control unit 73 obtains the signal level “II” monitored by the level monitoring unit 22. At this time, the signal level “II” obtained this time by the phase shifter control unit 73 has not fallen below the signal level “I” previously obtained by the phase shifter control unit 73 (Step S3; No). In this case, the phase shifter control unit 73 adjusts the phase of the phase shifter 70 in the minus direction. For example, the phase shifter control unit 73 changes the phase of the phase shifter 70 from the initial value of 140 degs. by −20 degs. as the set phase (Step S4).

Next, the level monitoring unit 22 monitors a signal level “III” input from the feedback path (directional coupler 35, QDEM 52, and ADC 51) (Step S5). The phase shifter control unit 73 obtains the signal level “III” monitored by the level monitoring unit 22. At this time, the signal level “III” obtained this time by the phase shifter control unit 73 has fallen below the signal level “I” previously obtained by the phase shifter control unit 73 (Step S6; Yes). In this case, it is understood that there is a possibility of being able to search for the optimum phase (see “spec” indicated by a dotted line in FIG. 6) by adjusting the phase of the phase shifter 70 in the minus direction by the phase shifter control unit 73. Therefore, the phase shifter control unit 73 further adjusts the phase of the phase shifter 70 in the minus direction. For example, the phase shifter control unit 73 changes the phase of the phase shifter 70 from the current value of 120 degs. by −20 degs. as the set phase (Step S4).

Next, the level monitoring unit 22 monitors a signal level “IV” input from the feedback path (directional coupler 35, QDEM 52, and ADC 51) (Step S5). The phase shifter control unit 73 obtains the signal level “IV” monitored by the level monitoring unit 22. At this time, the signal level “IV” obtained this time by the phase shifter control unit 73 has fallen below the signal level “III” previously obtained by the phase shifter control unit 73 (Step S6; Yes). Therefore, the phase shifter control unit 73 further adjusts the phase of the phase shifter 70 in the minus direction. For example, the phase shifter control unit 73 changes the phase of the phase shifter 70 from the current value of 100 degs. by −20 degs. as the set phase (Step S4).

Next, the level monitoring unit 22 monitors a signal level “V” input from the feedback path (directional coupler 35, QDEM 52, and ADC 51) (Step S5). The phase shifter control unit 73 obtains the signal level “V” monitored by the level monitoring unit 22. At this time, the signal level “V” obtained this time by the phase shifter control unit 73 has fallen below the signal level “IV” previously obtained by the phase shifter control unit 73 (Step S6; Yes). Therefore, the phase shifter control unit 73 further adjusts the phase of the phase shifter 70 in the minus direction. For example, the phase shifter control unit 73 changes the phase of the phase shifter 70 from the current value of 80 degs. by −20 degs. as the set phase (Step S4).

Next, the level monitoring unit 22 monitors the signal level “VI” input from the feedback path (directional coupler 35, QDEM 52, and ADC 51) (Step S5). The phase shifter control unit 73 obtains the signal level “VI” monitored by the level monitoring unit 22. At this time, the signal level “VI” obtained this time by the phase shifter control unit 73 has not fallen below the signal level “V” previously obtained by the phase shifter control unit 73 (Step S6; No). In this case, the phase shifter control unit 73 determines the phase (80 degs.) at the time of adjustment to the previous signal level “V” as the optimum phase.

For example, the characteristics of the phase of the phase shifter 70 and the signal levels “I” to “VI” input from the feedback path (directional coupler 35, QDEM 52, and ADC 51) can be represented by a curve as illustrated in FIG. 6. By adjusting the phase of the phase shifter 70, the phase shifter control unit 73 determines the phase at which the signal level monitored by the level monitoring unit 22 is minimized in the curve illustrated in FIG. 6 as the optimum phase. That is, the phase shifter control unit 73 determines the phase at which the signal level resulting from the combination of the reflected wave generated from the input side of the LNA 64 and the received signal (received wave) leaked from the circulator 36 to the side of the PA 34 is minimized as the optimum phase. This enables the phase shifter control unit 73 to cancel (cancel out or attenuate) the received wave leaking from the circulator 36 to the side of the PA 34. As a result, the level of the reflected wave reaching the end portion 38a of the antenna 38 becomes small, and also in the RX period, the radio communication apparatus 1 is not influenced by the reflected wave and can secure the value of the VSWR at the ideal value.

Note that in the example of FIG. 6, the set phase for adjusting the phase of the phase shifter 70 is set to 20 degs. However, in order to improve the performance of canceling the reflected wave, the set phase may be set to 5 degs. or 10 degs. Furthermore, in the VSWR processing in FIGS. 5 and 6, when the phase of the phase shifter 70 is adjusted, the phase of the phase shifter 70 is adjusted in the plus direction first and then adjusted in the minus direction. However, the phase of the phase shifter 70 may be adjusted in the minus direction first and then adjusted in the plus direction.

Effects

As described above, in the radio communication apparatus 1 according to the embodiment, the transmission signal amplified by the first amplifier (PA 34) is transmitted via the circulator 36, and the received signal received via the circulator 36 is amplified by the second amplifier (LNA 64). Here, the radio communication apparatus 1 according to the embodiment includes a control section (phase shifter control unit 73) and the phase shifter 70. The phase shifter control unit 73 outputs control information on the basis of the signal level between the PA 34 and the circulator 36. The phase shifter 70 is provided between the circulator 36 and the LNA 64 and adjusts the phase of the reflected wave generated from the input side of the LNA 64 on the basis of the control information.

As described above, with the radio communication apparatus 1 according to the embodiment, by using the phase shifter 70, it may be unnecessary to provide a circulator that terminates the reflected wave from the input side of the LNA 64 between the circulator 36 and the LNA 64 (specifically SW 65). Therefore, with the radio communication apparatus 1 according to the embodiment, the circulator that terminates the reflected wave from the input side of the LNA 64 is not used, whereby the increase in the circuit scale of the apparatus can be suppressed. Furthermore, in the radio communication apparatus 1 according to the embodiment, the phase of the reflected wave from the input side of the LNA 64 is adjusted by the phase shifter 70, whereby the received wave leaked from the circulator 36 to the side of the PA 34 is canceled (canceled out or attenuated). Therefore, with the radio communication apparatus 1 according to the embodiment, the VSWR can be improved as compared with a method of terminating a reflected wave with a circulator.

Furthermore, in the radio communication apparatus 1 according to the embodiment, the signal level represents a signal level resulting from the combination of the reflected wave and the received signal (received wave). Therefore, the control unit (phase shifter control unit 73) generates control information that minimizes the signal level, and outputs the control information to the phase shifter 70. On the basis of the control information generated by the phase shifter control unit 73, the phase shifter 70 adjusts the phase of the reflected wave by the set phase that is preset. As a result, the level of the reflected wave reaching the end portion 38a of the antenna 38 provided at a subsequent stage of the circulator 36 becomes small, and the radio communication apparatus 1 is not influenced by the reflected wave and can secure the value of VSWR at the ideal value.

Furthermore, the radio communication apparatus 1 according to the embodiment further includes the monitoring unit (level monitoring unit 22) and the distortion compensation unit (DPD distortion compensation unit 21). The level monitoring unit 22 monitors the signal level between the PA 34 and the circulator 36 or the transmission signal fed back from the output of the PA 34 by using the feedback path (directional coupler 35, QDEM 52, and ADC 51). The DPD distortion compensation unit 21 corrects a distortion characteristic due to the PA 34 on the basis of the signal input to the PA 34 and the transmission signal monitored by the level monitoring unit 22. As described above, with the radio communication apparatus 1 according to the embodiment, the feedback path can be made common between the monitoring of the signal level and the monitoring of the transmission signal, and the increase in the circuit scale of the apparatus can be suppressed.

### OTHER EMBODIMENTS

Furthermore, each constituent element of each unit as illustrated in the drawings in the embodiment does not need to be physically configured as illustrated in the drawings. That is, the specific form of distribution and integration of each unit is not limited to that illustrated in the drawings, and all or a part thereof may be distributed or integrated functionally or physically in any units, depending on various loads, usage conditions, and the like.

Furthermore, as for various processing performed in each device, all or any part thereof may be executed on a central processing unit (CPU) (or a microcomputer such as a micro processing unit (MPU) and a micro controller unit (MCU)). Furthermore, all or any part of the various processing may be executed on a program that executes an analysis at a CPU (or the microcomputer such as an MPU and an MCU) or on hardware using a wired logic.

The radio communication apparatus 1 according to the embodiment can be achieved, for example, as a radio communication apparatus 100 with the following hardware configuration.

FIG. 7 is a diagram illustrating an example of the hardware configuration of the radio communication apparatus 100. As illustrated in FIG. 7, the radio communication apparatus 100 includes a processor 101, a memory 102, and an analog circuit 103. An example of the processor 101 includes a CPU, a digital signal processor (DSP), and a field programmable gate array (FPGA). Furthermore, an example of the memory 102 includes a random access memory (RAM) such as a synchronous dynamic random access memory (SDRAM), a read only memory (ROM), and a flash memory.

The various processing performed in the radio communication apparatus 1 of the embodiment may be achieved by executing programs stored in various memories such as a nonvolatile storage medium by a processor. That is, a program corresponding to each processing executed by a baseband signal processor 10 and an arithmetic processor 20 may be recorded in the memory 102, and each program may be executed by the processor 101. Furthermore, the analog circuit 103 achieves a DAC 31, a QMOD 32, a PLL oscillator 33, a PA 34, a directional coupler 35, a circulator 36, a BPF 37, an idle voltage generation circuit 41, a pinch-off voltage generation circuit 42, and an SW 43. Furthermore, the analog circuit 103 achieves an ADC 51, a QDEM 52, a PLL oscillator 53, an ADC 61, a QDEM 62, a PLL oscillator 63, an LNA 64, an SW 65, and a phase shifter 70.

Note that in the above description, the various processing performed by the radio communication apparatus 1 of the embodiment are executed by the processor 101, but the present invention is not limited to this, and the various processing may be executed by a plurality of processors.

In one aspect, it is possible to improve the VSWR and suppress the increase in the mounting area of the apparatus.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication apparatus that transmits a transmission signal amplified by a first amplifier via a circulator and amplifies a received signal received via the circulator by a second amplifier, the radio communication apparatus comprising:
a controller that outputs control information based on a signal level between the first amplifier and the circulator; and
a phase shifter that is provided between the circulator and the second amplifier and adjusts a phase of a reflected wave generated from an input side of the second amplifier based on the control information.

2. The radio communication apparatus according to claim 1, wherein
the signal level represents a signal level resulting from a combination of the reflected wave and the received signal,
the controller generates the control information that minimizes the signal level and outputs the control information to the phase shifter, and
based on the control information, the phase shifter adjusts the phase of the reflected wave by a predetermined set phase.

3. The radio communication apparatus according to claim 1, the radio communication apparatus further comprising:
a monitoring unit that monitors the signal level between the first amplifier and the circulator or the transmission signal fed back from an output side of the first amplifier; and
a distortion compensation unit that corrects a distortion characteristic due to the first amplifier based on a signal input to the first amplifier and the transmission signal monitored by the monitoring unit.

4. A method of controlling a phase of a reflected wave implemented by a radio communication apparatus, the method comprising:
transmitting a transmission signal amplified by a first amplifier via a circulator;
amplifying a received signal received via the circulator by a second amplifier;
outputting control information based on a signal level between the first amplifier and the circulator; and
adjusting a phase of a reflected wave generated from an input side of the second amplifier based on the control information, by a phase shifter provided between the circulator and the second amplifier.
